(19) United States
(12) Patent Application Publication
(10) Pub. No.: US 2008/0317219 A1
(43) Pub. Date: Dec. 25, 2008

(54) Method and apparatus for context based voice dialing

(75) Inventor: Marcel Manzardo, Los Gatos, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Communications, Inc.

(21) Appl. No.: 11/820,930

(22) Filed: Jun. 21, 2007

(51) Int. Cl. H04M 3/424

(52) U.S. Cl. 379/88.01; 379/201.04

(57) ABSTRACT

A telecommunications device including an address book including a plurality of entries of party names and addresses, the entries including user-defined party contexts; a voice recognition unit configured to receive user input, the user input including names, numbers, and contexts of address book entries; a user context control agent configured to receive context inputs from the voice recognition unit and identify corresponding names and numbers therefrom; and an autodialer configured to dial a number identified by the user context control agent.

### BACKGROUND OF THE INVENTION

1. Field of the Invention

This invention relates to telecommunications systems. More particularly, the invention relates to methods for improved voice dialing.

2. Description of the Related Art

Voice dialing is an increasingly popular feature that greatly simplifies the task of dialing a telephone. Typically, a telephone is equipped with a voice recognition unit that receives an audio input in the form of names or numbers. The voice recognition unit detects the input name or number and causes either the number to be dialed or a lookup of the number corresponding to the name, whereupon the number is dialed.

Often a user will store a name and then have no recollection of the associated context. For example, the user may store the name and number of his insurance agent, “John Smith.” However, because he does not regularly call about insurance, he may not remember his insurance agent's name. If this is the case, then he cannot use voice dialing unless he has also stored an “Insurance Agent” entry. However, this can be unnecessarily duplicative and wasteful. Thus, typically, the user must perform a manual search, which can be tedious and time-consuming.

### SUMMARY OF THE INVENTION

A dialer system embodying principles of the present invention includes an address book including a plurality of entries, each entry including a name associated with a corresponding telephone number and one or more fields defining user contexts; a voice detector configured to detect audio user input; a search engine configured to receive the audio input from the voice detector and search the address book for entries associated with the audio user input, the audio user input including one or more user contexts, and configured to output one or more numbers corresponding to the audio input; and a dialer configured to dial a selected one of the one or more output numbers. In some embodiments, the numbers are filtered by a presence and availability system according to a presence state.

A telecommunications device in accordance with embodiments of the present invention includes an address book including a plurality of entries of party names and addresses, the entries including user-defined party contexts; a voice recognition unit configured to receive user input, the user input including names, numbers, and contexts of address book entries; a user context control agent configured to receive context inputs from the voice recognition unit and identify corresponding names and numbers therefrom; and an autodialer configured to dial a number identified by the user context control agent.

A telecommunications method in accordance with embodiments of the present invention includes storing a plurality of party names and numbers in association with one or more user-defined party contexts; receiving a voice input corresponding to a party context; identifying one or more telephone numbers corresponding to the party context; and automatically dialing a number corresponding to the party context. In some embodiments, the method further includes including providing an output to a user of a plurality of numbers corresponding to the party context.

A telecommunications system in accordance with embodiments of the present invention includes a network; a plurality of network clients; an address server including: a plurality of user address books having a plurality of entries each entry including a name associated with a corresponding telephone number and one or more fields defining user contexts; a voice detector configured to detect audio user input; a search engine configured to receive the audio input from the voice detector and search the address book for entries associated with the audio user input, the audio user input including one or more user contexts, and configured to output one or more numbers corresponding to the audio input; and a dialer configured to dial a selected one of the one or more output numbers such that a client endpoint can call the number.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 illustrates an exemplary system according to embodiments of the present invention.

FIG. 2 illustrates an exemplary system according to embodiments of the present invention.

FIG. 3 illustrates and exemplary user interface according to embodiments of the present invention

FIG. 4 is a flowchart illustrating operation of an embodiment of the present invention.

FIG. 5 illustrates exemplary operation of voice dialing according to embodiments of the present invention.

FIG. 6 is a flowchart illustrating operation of an embodiment of the present invention.

FIG. 7 illustrates exemplary operation of voice dialing according to embodiments of the present invention.

FIG. 8 is a flowchart illustrating operation of an embodiment of the present invention.

FIG. 9 illustrates an exemplary system according to embodiments of the present invention.

FIG. 10 illustrates an exemplary device according to embodiments of the present invention.

FIG. 11 illustrates an exemplary device according to embodiments of the present invention.

### DETAILED DESCRIPTION OF EMBODIMENTS OF THE INVENTION

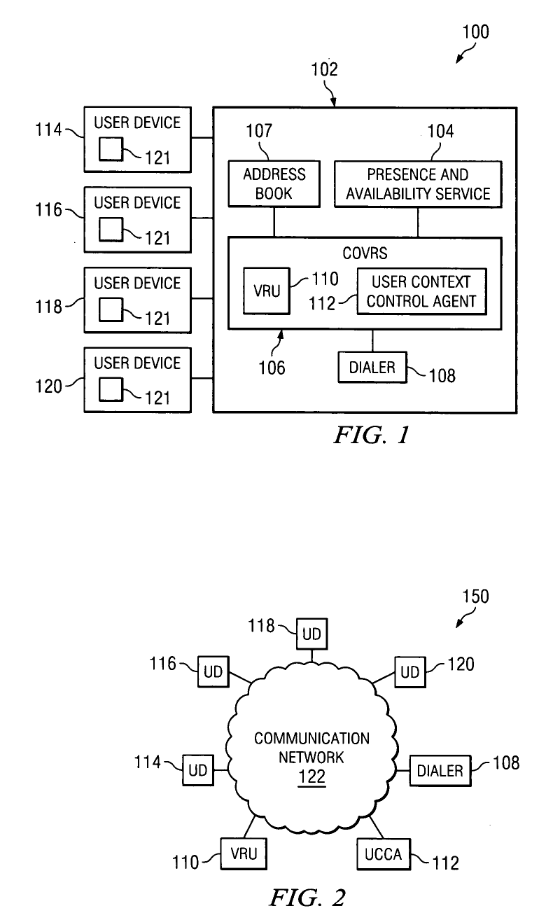

Turning now to the drawings and, with particular attention to FIG. 1, a diagram of a telecommunications system 100 according to an embodiment of the present invention is shown. The system 100 may be implemented as a telecommunications service 102 including a context-oriented voice recognition service 106 (COVRS) connected to or in communication with an autodialer 108. The COVRS 106 may include a voice recognition unit 110 and a user context control agent (UCCA) 112, as will be discussed in greater detail below. In some embodiments, the system 100 further includes a presence and availability service (PAS) 104 connected to or in communication with the COVRS 104. In addition, an address or contact list book 107 may be provided which stores for each user one or more party names, numbers, contacts, and contexts, as will be explained in greater detail below.

User devices, such as user devices 114, 116, 118, 120 may be connected to or in communication with the telecommunications service 102. In certain embodiments, the user devices may be implemented as telephones, cellular telephones, PDAs, computers, hard or soft clients, etc. For example, user devices 114, 116, 118, 120 may be embodied as personal computers implementing the Windows XP operating system and the Explorer web browser. In addition, the user devices 114, 116, 118, 120 may include telephony and other multimedia messaging capability using, for example, peripheral cameras, Webcams, microphones, and speakers (not shown) or peripheral telephony handsets, such as the optPoint handset available from Siemens Communication, Inc.

The user devices 114, 116, 118, 120 thus may implement one or more telephony applications 121 including or in communication with voice recognition systems in accordance with embodiments of the present invention.

In certain embodiments, the system 100 may also include other hardware and/or software components (e.g., gateways, proxy servers, registration server, presence servers, redirect servers, databases, applications, etc.) such as, for example, hardware and software used to support a SIP (Session Initiation Protocol) or other protocol based infrastructure for the system 100 and allow the registration of SIP devices in the system 100.

As will be discussed in greater detail below, in certain embodiments, the COVRS 106 receives voice inputs from one or more of the user devices 114, 116, 118, 120. The VRU 110 detects the voice input and identifies the word or number spoken using, for example, a voice recognition algorithm, and then either dials the corresponding number via the dialer 108, or causes a search engine in the user context control agent 112 (UCCA) to search the stored user contexts. If the UCCA 112 finds a match, it causes the dialer 108 to dial the corresponding number. The user and the called party are then connected. If the UCCA 112 finds more than one match, in some embodiments, it causes COVRS 106 (and, in particular, in some embodiments, the VRU 110) to return an audio response to the user identifying the matches. The user can then select which one is to be called, for example, by a voice response or key input. When the response is received, the dialer 108 calls the corresponding number. Suitable VRUs 110 that may be appropriately modified for use in conjunction with the present invention are available from a variety of vendors.

The COVRS 106 may be implemented in hardware and/or software operating on one or more servers, computer systems, host or mainframe computers, workstations, etc. In some embodiments, the COVRS 106 may be operating on some or all of the same devices as other components in the system 100.

In some embodiments, the COVRS 106 additionally receives inputs from a presence and availability service (PAS) 104. The presence and availability service 104 may be or include an application that monitors the presence and availability of devices or identities. That is, the presence and availability service 104 monitors the presence state or device context of one or more devices. The presence and availability service 104 may further determine a user presence status or identity context from the device information. In certain embodiments, the presence and availability service 104 provides the presence information and/or status to the UCCA 112. The UCCA 112 can identify which parties have a user context match as well as a presence match. The dialer 108 can then dial a corresponding number.

The presence and availability service 104 may be implemented in software operating on one or more servers, computer systems, host or mainframe computers, workstations, etc. In some embodiments the presence and availability service 104 may be operating on some or all of the same device(s) as other components in the system 100.

In some embodiments, the presence and availability service 104 may be or include an application that communicates with or is connected to one or more registered devices (e.g., devices 114, 116, 118, 120), that allows devices to register with the system 100 or helps facilitate their registration, etc. For example, in a SIP environment, the devices 114, 116, 118, 120 may be registered with the system 100 and may show up or be described in registration databases as being assigned to particular identities. The UCCA 112 may register with the presence and availability service 104 and receive device or identity context and/or other information from the presence and availability service 104 regarding the devices 114, 116, 118, 120. In some embodiments, the presence and availability service 104 may provide device and/or identity context information upon request, periodically, or in accordance with some other plan or procedure. A presence and availability service that may be suitably adapted for use in conjunction with the present invention is the OpenScape system, available from Siemens Comm., Inc.

In addition, one or more participant telephony client applications or “soft” clients 121 may be provided. The telephony client applications 121 allow users to implement telephony services and voice functionality according to embodiments of the present invention. The client applications 121 may be implemented as including any suitable interface, including for example such as browser-type interfaces, as DTMF (dual tone multi-frequency) interfaces, or voice command interfaces. As noted above, the client applications 121 may be implemented on the user devices, for example as part of telephony or conferencing programs or clients. More generally, the client applications 121 may be implemented in hardware and/or software operating on one or more servers, computer systems, host or mainframe computers, workstations, etc. In some embodiments, the client applications 121 may be operating on some or all of the same devices as other components in the system 100.

It is noted that, while illustrated as having a common dialer 108 and central COVRS 106, in certain embodiments of the present invention, the COVRS 106, including the voice recognition unit 110 and the UCCA 112, the address book 107, and the dialer 108 are implemented locally at one or more or each of the user devices 114, 116, 118, 120.

Finally, it is noted that, the service 102 and/or the clients 114, 116, 118, 120 may be provided with one or more databases or memories, such as memory 107, for storing address book and context and presence information for users.

In certain embodiments of the present invention, one or more of the components of the system 100 may be connected to or in communication with each other via a communication network. For example, turning now to FIG. 2, a system 150 including the components of the system 100 is illustrated, wherein some or all of the components are in communication via a network 122. The network 122 may be or include the Internet, World Wide Web, a local area network, or some other public or private computer, cable, telephone, client/server, peer-to-peer, or communication network or intranet. In some embodiments, the communication network can also include other public and/or private wide area networks, local area networks, wireless networks, data communications networks, or connections, intranets, routers, satellite links, microwave links, cellular or telephone networks, radio links, fiber optic transmission lines, ISDN lines, T1 lines, DSL connections, the public switched telephone network (PSTN), etc. Moreover, as used herein, communications include those enabled by wired or wireless technology. In some embodiments, some or all of the network 122 may be implemented using a TCP/IP network and may implement voice or multimedia over IP using, for example, the Session Initiation Protocol (SIP).

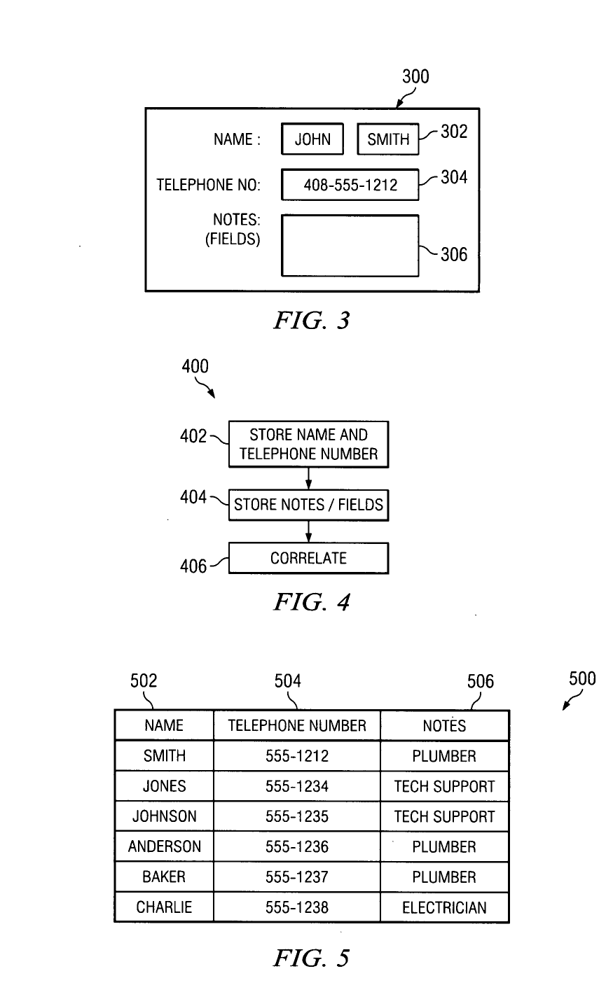

As discussed above, one aspect of the present invention relates to a voice dialing system making use of non-name and non-number address book fields or entries defining a party or user context, i.e., a user entered context that may be associated with, or used to help identify, a party entry. For example, shown in FIG. 3 is an exemplary address book entry 300. The entry 300 may be exemplary of a graphical user interface based address book provided by or in conjunction with the user devices or the VRU 110. The address book entry may be provided, for example, by a web-browser type interface including or in association with a communications suite.

As shown, the entry 300 includes a name entry 302, a telephone number entry 304, and a notes field 306. In operation, a user can enter a name and a corresponding telephone number. In addition, the user may make any desired entry into the notes field 306. For example, the notes field 306 could be used to define a user or party context for the party name entry. For example, if the entry is for John Smith, and John Smith is the user's insurance agent, the user could enter “Insurance Agent” into the notes field 306. The VRU 110 will then cause the UCCA 112 to search the notes field entries for a context as well as the name and telephone number entries when an input is received. It is noted that, in certain embodiments, additional fields may be provided and may be used by the UCCA 112 in accordance with the present invention. For example, such fields could include “Company,” “Title,” “City,” “Address,” etc. Such fields may allow user entry of text or may be associated with a preset drop down menu choice.

FIG. 4 illustrates a flowchart 400 of an embodiment of the present invention. The particular arrangement of elements in the flowchart 400 is not meant to imply a fixed order to the elements; embodiments can be practiced in any order that is practicable. In particular, flowchart 400 illustrates user configuration of the address book.

In a step 402, the user can store a name and a telephone number. Alternatively, the user may import specific user entries from a corporate or other directory. Thus, for example, the user may open an application program or other user interface related to the address book and can enter, either by typing in appropriate text or other means, the name and number to be stored. In a step 404, the user can store one or more notes or other field entries to store a user or party context for use by the COVRS 106. For example, as discussed above, this can include the user making an appropriate text entry or selecting from one or more menu options. When the user saves the entry, the system receives it and can correlate the entry in a step 406 against the voice recognition algorithms and can associate, for example, the particular field with the particular telephone number or numbers.

FIG. 5 illustrates operation of an embodiment of the present invention by way of example. Shown is an exemplary address book or listing 500 for a particular user. Shown are names 502, telephone numbers 504, and notes or contexts 506. In the names field 502 are shown party names Smith, Jones, Johnson, Anderson, Charlie and Baker with corresponding telephone number and notes fields 504, 506, respectively. In particular, Smith, Anderson, and Baker are all listed as Plumber, while Jones and Johnson are Tech Support and Charlie is listed as electrician.

In operation, a user can activate his voice dialing function and speak either the name, the number, or the notes or other contextual field to dial a number. For example, if the user says “Electrician,” the system will dial Charlie's number, because he is the only electrician. If the user says “Plumber,” then the system will give the user an option of dialing either Smith, Anderson, or Baker. For example, this may take the form of the VRU 110 generating an audio message, such as “Press or say 1 to dial Smith, press or say 2 to dial Baker, Press or say 3 to dial Anderson.” Similarly, if the user speaks “Tech Support,” he may be given the option of “Dial 1 for Jones or dial 2 for Johnson.”

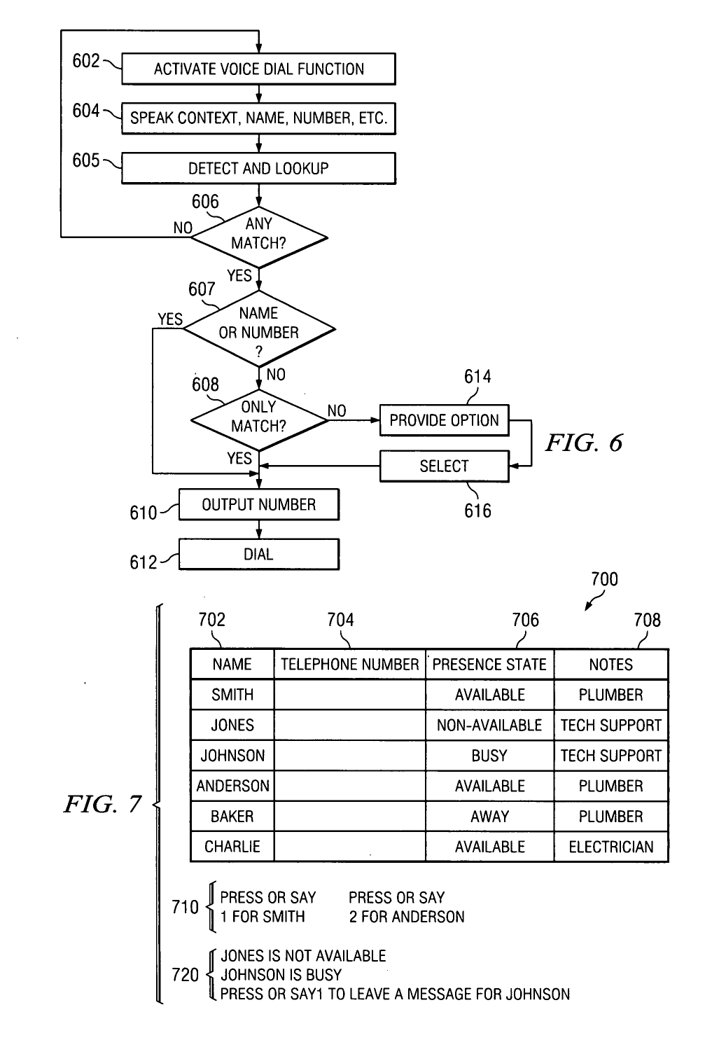

FIG. 6 illustrates a flowchart 600 of an embodiment of the present invention. The particular arrangement of elements in the flowchart 600 is not meant to imply a fixed order to the elements; embodiments can be practiced in any order that is practicable.

Initially, in a step 602, a user can activate his voice dial function. For example, he can press a button or speak a command (not shown) that is received by the user device 114, 116, 118, 120. In a step 604, the user can speak the appropriate context or other entry, such as name, number, etc. In a step 605, the spoken entry is received by the VRU 110, which detects the input speech and causes the UCCA 112 to perform a lookup. If there is no match, as determined in a step 606, the process ends or returns to the beginning step 602. If a name or number is detected, in a step 607, then the corresponding number is output to the autodialer 108 in a step 610 and dialed in a step 612. Otherwise, a user or party context is found. If the detected context is the only context match found by the UCCA 112, as determined in a step 608, then in a step 610, the appropriate telephone number is accessed from memory (not shown) by the UCCA 112 and output to the autodialer 108. The dialer 108 can then dial the number, in a step 612. In some embodiments, the found number and perhaps name entry also may be spoken to the user by the VRU 110.

In step 608, if it was determined that there was more than one match, then in a step 614, the UCCA 112 can cause a list of options and actions to be provided to the user, for example, spoken to the user by the VRU 110. For example, the names and/or numbers could be listed in order, ad the user can be given the option to select one, e.g., either by selecting or speaking an index or saying “call” after the entry is read. Alternatively, the user could simply say “call,” and the UCCA 112 could select one of the numbers to call, either randomly or through some other predetermined algorithm. Thus, in a step 616, the entry is selected and the number output to the dialer 108 in step 610 and dialed in step 612.

As discussed above, in certain embodiments of the present invention, the UCCA 112 makes use of information concerning the presence state or device context of a party to be called. That is, the search engine in the UCCA 112 may filter its results based on the presence state or device context. Context for a device may describe the work or non-work state, and/or the availability or non-availability state, that the device is in. In some embodiments, potential presence states or device contexts may include “available,” “non-available,” “busy,” “away,” “unknown,” “partially available” (e.g., a device may be “busy” on a voice channel but available on an instant messaging channel), “be right back,” “present,” “not present,” etc. In some embodiments, different applications may be used to set, monitor or change a device context for a device. For example, software operating on a computer may allow an identity to indicate manually or automatically that the computer is unavailable for email, instant messaging, file transfer or other communications at the current time, at a specific later time, during a time range, etc. As another example, a wireless and instant messaging capable PDA may be considered as having a device context as “available” by a presence and availability service 104 when the PDA is online and a device context of “unavailable” by the presence and availability service 104 when the PDA is offline. In addition, a telephony program may define a user as “busy” when he is active with another call.

FIG. 7 illustrates operation of an embodiment of the present invention by way of example. Shown is an exemplary address book or listing for a particular user 700. Shown are names entries 702, telephone number entries 704, presence state or device context fields 706, and notes or user or party contexts 708. In particular, shown are names Smith, Jones, Johnson, Anderson, Charlie and Baker with corresponding telephone number 704 and notes entries or context 708. In particular, Smith, Anderson, and Baker are all listed as Plumber, while Jones and Johnson are Tech Support and Charlie is electrician.

In addition, shown are device contexts or presence states 706 for the corresponding telephone numbers. As shown, Smith, Anderson, and Charlie are available, while Jones is non-available, and Johnson is busy.

In operation, a user can activate his voice dialing function and speak either the name, the number, or the notes or other contextual field to dial a number. The system and particularly the UCCA 112 will take into account the user's presence state before dialing a number. For example, if the user says “Electrician,” the system will dial Charlie's number, because he is the only electrician and he is indicated to be available. If the user says “Plumber,” then the system will determine that Smith and Anderson are available and that Baker is busy. Thus, in some embodiments, the system will give the user an option of dialing either Smith or Johnson, e.g., at 710. For example, this may take the form of an audio message such as “Press or say 1 to dial Smith, press or say 2 to dial Johnson.” In other embodiments, the UCCA 112 may simply select one, or select one according to a predetermined, user-defined preference.

Similarly, if the user speaks “Tech Support,” the system will identify Jones and Johnson. However, Jones is not available and Johnson is busy. Thus, the system may give the option of “Dial 1 to leave a message for Johnson” at 7202. The system may also provide an indication that Jones is not available or that Johnson is busy. It is noted that, in certain embodiments, such an option may be provided whenever a party is not available, and that a listing may also be provided of not available parties, as well. In other embodiments, the system could either simply call Johnson's voice mail automatically or simply inform the user to call back later.

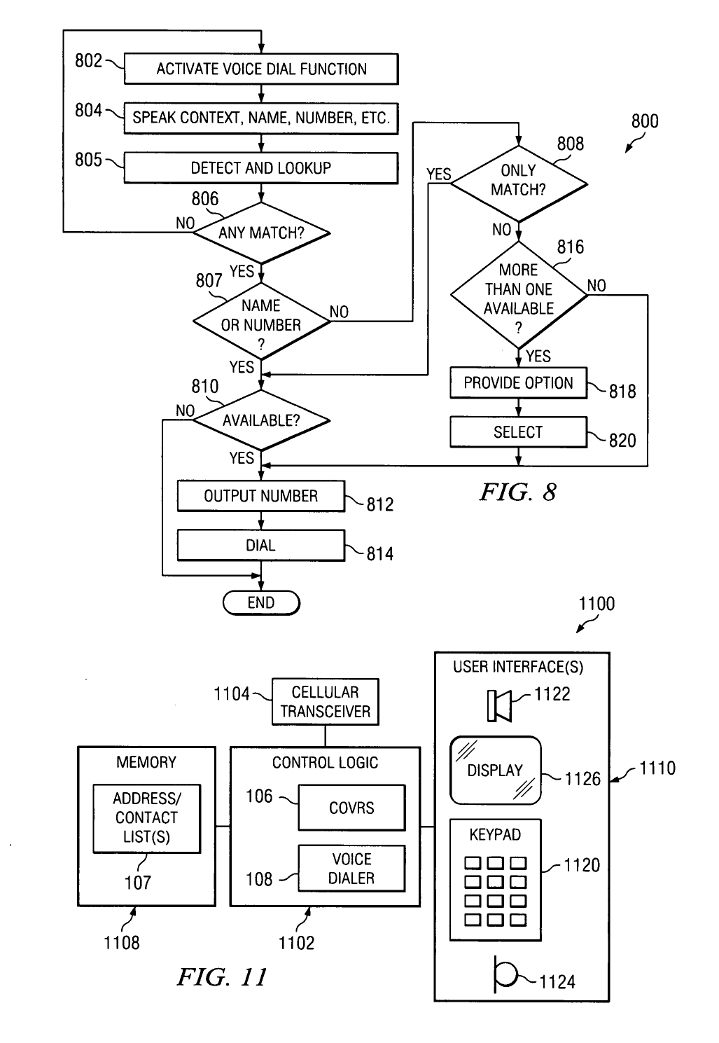

FIG. 8 illustrates a flowchart 800 of an embodiment of the present invention. The particular arrangement of elements in the flowchart 800 is not meant to imply a fixed order to the elements; embodiments can be practiced in any order that is practicable.

Initially, in a step 802, a user can activate his voice dial function. For example, he can press a button or speak a command (not shown) that is received by the user device. In a step 804, the user can speak the appropriate context or other entry. In a step 805, the spoken entry is received by the VRU 110, which detects the input speech and causes the UCCA 112 to perform a lookup. If there is no match, as determined in a step 806, the process ends or returns to the beginning step 802. If a name or number is detected, as determined in a step 807, then the process proceeds to an availability determination, in a step 810. If the party is available, then the number is output to the dialer 108 in a step 812 and dialed in a step 814.

If a user context is found and the detected user context is the only match, as determined in a step 808, then in a step 810, the UCCA 112 can access the presence and availability service 104 to determine if the party selected is available. If so, then in a step 812, the appropriate telephone number is accessed from memory (not shown) and output to the dialer 108. The dialer 108 can then automatically dial the number, in a step 842. In some embodiments, the found number and perhaps name entry also may be spoken to the user by the VRU 110. If the party is not available, then the process ends. In some embodiments, if the called party is busy, the VRU 110 may provide an option of leaving a message or calling back later.

In step 808, if it was determined that there was more than one match, then in a step 816, the UCCA 112 can access the presence and availability service 104 to determine which, if any, of the matching parties are available. If only one is available, then that number is output to the dialer 108 in step 812 and dialed in step 814.

However, if more than one is available, then the UCCA 112 can cause a list of options and actions to be provided to the user by the VRU 110 or other interface, in a step 818. For example, the names and/or numbers could be listed in order, ad the user can be given the option to select one, e.g., either by entering or speaking an index or saying “call” after the entry is read. Alternatively, the user could simply say “call,” and the system, and particularly, the UCCA 112, could select one of the numbers to call, either randomly or through some other predetermined algorithm. Thus, in a step 820, the entry is selected and the number output to the dialer 108 in step 812 and dialed in step 814.

It is noted that, while discussion of presence states has been in terms of a device context, it may equally be implemented in terms of an identity context. In some embodiments an identity may be or include an individual person or a group of people. An identity context for an identity could be a state of “in a meeting.” “on vacation,” “in the office,” “out of the office,” “roaming,” “offline,” “online,” “in transit,” “mobile,” etc. Thus, the identify context describes the implied availability of the identity. An identity may have one or more devices associated with it. For example, a person may have an associated office telephone, a home telephone, a cellular telephone, computer, PDA, etc. Each device may have an associated device context. For example, the person's office telephone may be busy, set to “do not disturb,” automatic call forwarding, offline, etc. The system of the present invention may use either device or identity context as its presence state basis. Alternatively, a conversion between identity and device context, or vice versa, may be desired. Co-pending, commonly assigned patent applications METHOD AND SYSTEM FOR MAPPING IDENTITY CONTEXT TO DEVICE CONTEXT, described in U.S. Patent Publication No. 2005/0071429, and METHOD AND APPARATUS FOR MAPPING DEVICE CONTEXT TO IDENTITY CONTEXT, described in U.S. Patent Publication No. 2005/0071506, which are hereby incorporated by reference in its entirety as if fully set forth herein, describe such methods.

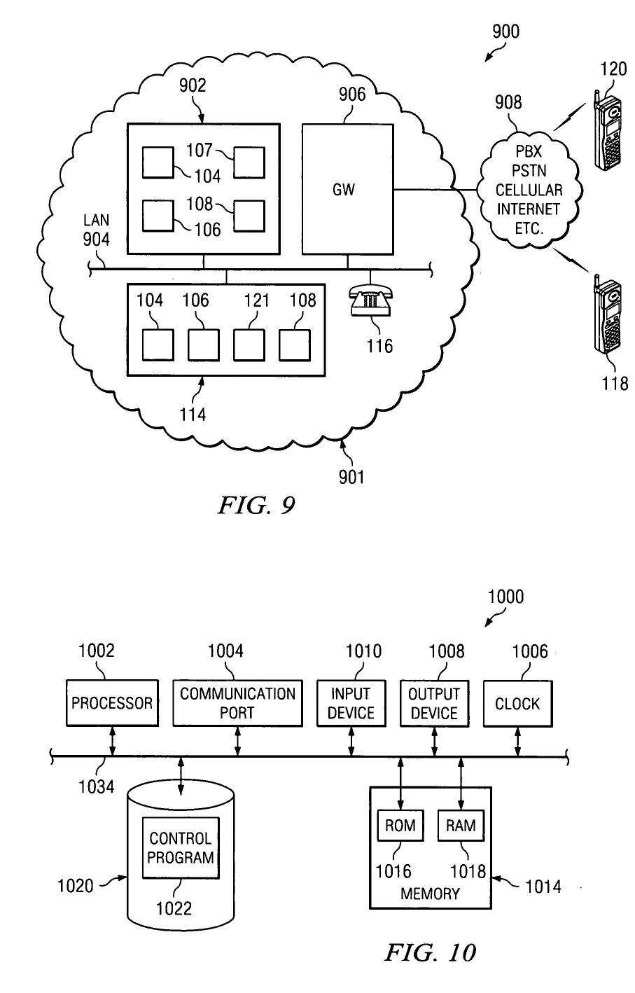

An exemplary network architecture that may be suitable for use with embodiments of the present invention is shown in FIG. 9. As shown, the system 900 includes an enterprise network 901 and a public network 908. The enterprise network 901 may include a wired or wireless local area network (LAN) 904. A server 902 may be coupled to the LAN 904. In some embodiments, the server 904 may implement a PAS 104, a COVRS 106, address book 107, and a dialer 108. In other embodiments, the COVRS 106, address book 107, dialer 108 and a presence client (not shown) are implemented at one or more of the user devices.

Also coupled, connected to or in communication with the LAN 304 may be one or more user devices 114, 116. The user devices 114, 116 may be implemented as personal computers 114 or digital telephones 116, such as Internet Protocol (IP) based digital telephones. An exemplary personal computer 114 may also include an interface or browser portal, for accessing server functions, as well as a telephony client 121. As noted above, in some embodiments, the personal computer 114 may itself implement an address book 107, dialer 108, and COVRS 106, typically in conjunction with a browser interface. The telephone 116 may also, in some embodiments, implement such functionality. Typically, in such embodiments, the user device would also include software or other clients 114, 116 to access the PAS 104.

A gateway 906 may also be coupled to the LAN 904. The gateway 906 provides an interface to the public network 908, which may be implemented, for example, as one or more of the PSTN, cellular telephone network, Internet, one or more PBX's, and the like. One or more user devices 118, 120, which may be implemented as one or more telephones or cellular telephones, may be in communication with the public network 908. In certain embodiments, cellular telephones 118, 120 may be equipped with a dialer 108, address book 107, and COVRS 110, as well as a presence client, in accordance with embodiments of the present invention. In other embodiments, the telephones 118, 120 may make use of server resources.

Now referring to FIG. 10, a representative block diagram of a computer or processing device 1000 suitable for use as a user device or as a server according to embodiments of the present invention is shown. In some embodiments, the computer 1000 may include or operate a telephony client 121, user interface, COVRS 106, and dialer 108 and PAS client. The computer 1000 may also operate a web browser program. In server embodiments, the computer 1000 also may implement a PAS 104. The computer 1000 may be embodied as a single device or computer, a networked set or group of devices or computers, a workstation, mainframe or host computer, etc. In some embodiments, the server 1000 may implement one more elements of the methods disclosed herein.

The computer 1000 may include a processor, microchip, central processing unit, or computer 1002 that is in communication with or otherwise uses or includes one or more communication ports or network interfaces 1004 for communicating with user devices and/or other devices. The communication ports 1004 may include such things as local area network adapters, wireless communication devices, Bluetooth technology, etc. The computer 1000 also may include an internal clock element 1006 to maintain an accurate time and date for the computer 1000, create time stamps for communications received or sent by the computer 1000, etc.

If desired, the computer 1000 may include one or more output devices 1008 such as a printer, infrared or other transmitter, antenna, audio speaker, display screen or monitor, text to speech converter, etc., as well as one or more input devices 1010 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the computer 1000 may include a memory or data storage device 1020 to store information such as the address book, as well as software, databases, documents, communications, device drivers, etc. The memory or data storage device 1020 may be implemented as an appropriate combination of magnetic, optical and/or semiconductor memory, and may include, for example, Read-Only Memory (ROM), Random Access Memory (RAM), a tape drive, flash memory, a floppy disk drive, a Zip™ disk drive, a compact disc and/or a hard disk. Thus, the storage device 1020 may include various combinations of moveable and fixed storage. The computer 1000 also may include memory 1014, such as ROM 1016 and RAM 1018.

The processor 1002 and the data storage device 1020 in the computer 1000 each may be, for example: (i) located entirely within a single computer or other computing device; or (ii) connected to each other by a remote communication medium, such as a serial port cable, telephone line or radio frequency transceiver. In one embodiment, the computer 1000 may be implemented as one or more computers that are connected to a remote server computer, as will be explained in greater detail below.

A conventional personal computer or workstation with sufficient memory and processing capability may be used as the computer 1000. The computer 1000 may be capable of high volume transaction processing, performing a significant number of mathematical calculations in processing communications and database searches. A Pentium™ microprocessor such as the Pentium III™ or IV™ microprocessor, manufactured by Intel Corporation may be used for the processor 1002. Other suitable processors may be available from Motorola, Inc., AMD, or Sun Microsystems, Inc. The processor 1002 also may be embodied as one or more microprocessors, computers, computer systems, etc.

Software may be resident and operating or operational on the computer 1000. The software may be stored on the data storage device 1020 and may include one or more control programs 1022 for operating the computer. The control programs 1022 may include the user interface, the COVRS 106, the dialer 108, the telephony client 121, and the presence client (or PAS 104, in server implementations).

The program 1022 may control the processor 1002. The processor 1002 may perform instructions of the control program 1022, and thereby operate in accordance with the methods described in detail herein. The control program 1022 may be stored in a compressed, uncompiled and/or encrypted format. The control program 1022 furthermore includes program elements that may be necessary, such as an operating system, a graphical user interface program, a browser, a database management system and device drivers for allowing the processor 1002 to interface with peripheral devices, databases, etc. Appropriate program elements are known to those skilled in the art, and need not be described in detail herein. Information regarding other application program data may be stored in application databases (not shown)

According to some embodiments, the instructions of the control program may be read into a main memory from another computer-readable medium, such as from the ROM 1016 to the RAM 1018. Execution of sequences of the instructions in the control program causes the processor 1002 to perform the process elements described herein. In alternative embodiments, hard-wired circuitry may be used in place of, or in combination with, software instructions for implementation of some or all of the methods described herein. Thus, embodiments are not limited to any specific combination of hardware and software.

The processor 1002, communication ports 1004, clock 1006, output device 1008, input device 1010, data storage device 1020, ROM 1016 and RAM 1018 may communicate or be connected directly or indirectly in a variety of ways. For example, the processor 1002, communication ports 1004, clock 1006, output device 1008, input device 1010, data storage device 1012, ROM 1016 and RAM 1018 may be connected via a bus 1034.

While specific implementations and hardware/software configurations for the computer 1000 have been illustrated, it should be noted that other implementations and hardware configurations are possible and that no specific implementation or hardware/software configuration is needed. Thus, not all of the components illustrated in FIG. 10 may be needed for the computer 1000 implementing the methods disclosed herein.

As noted above, embodiments of the present invention may be implemented in or in conjunction with a telephone, such as a wireless or cellular telephone or PocketPC. An exemplary cellular telephone 1100 including voice dialing capabilities in accordance with an embodiment of the present invention is shown in FIG. 11. In some embodiments, the cellular telephone 1100 may implement one or more elements of the methods disclosed herein. As shown, the cellular telephone includes control logic 1102 and cellular transceiver 1104. The cellular transceiver 1104 allows communication over a cellular telephone network, such as a GSM or GPRS based cellular telephone network. The control logic 1102 generally controls operation of the cellular telephone and, in some embodiments, implements a voice dialer 108 and COVRS 106 (and presence client) in accordance with embodiments of the present invention.

The control logic 1102 interfaces to a memory 1118 for storing, among other things, contact or address lists 107. The control logic 1102 also interfaces to a user interface(s) 1110. The user interface(s) 1110 can include a keypad 1120, speaker 1122, microphone 1124, and display 1126. The keypad may include one or more “hard” keys and may be implemented in whole or in part as a cursor pointing device in association with one or more “virtual” keys on the display 1126. In general, a user may make use of the keypad 1120 and display 1126 to enter contact information, and may speak into the microphone to provide the audio input(s). It is noted that other interfaces, such as voice activated interfaces may be provided. Thus, the figure is exemplary only.

As noted above, in certain embodiments, the cell phone itself may implement the entire speech recognition-voice dialing system. In other embodiments, however, various components are provided at the server, in a manner similar to that discussed above.

As used herein, whether in the above description or the following claims, the terms “comprising,” “including,” “carrying,” “having,” “containing,” “involving,” and the like are to be understood to be open-ended, that is, to mean including but not limited to. Only the transitional phrases “consisting of” and “consisting essentially of,” respectively, shall be considered exclusionary transitional phrases, as set forth, with respect to claims, in the United States Patent Office Manual of Patent Examining Procedures (Eighth Edition, August 2001 as revised October 2006), Section 2111.03.

Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The above described preferred embodiments are intended to illustrate the principles of the invention, but not to limit the scope of the invention. Various other embodiments and modifications to these preferred embodiments may be made by those skilled in the art without departing from the scope of the present invention.

What is claimed is:

1. A dialer system, comprising:
an address book including a plurality of entries, each entry including a name associated with a corresponding telephone number and one or more fields defining user contexts;
a voice detector configured to detect audio user input;
a search engine configured to receive the audio input from the voice detector and search the address book for entries associated with the audio user input, the audio user input including one or more user contexts, and configured to output one or more numbers corresponding to the audio input; and
a dialer configured to dial a selected one of the one or more output numbers.

2. A system in accordance with claim 1, further including a presence system wherein the search engine is configured to filter the output one or more numbers according to a presence status.

3. A system in accordance with claim 1, further including means for selecting which of the one or more numbers is to be used by the dialer for calling.

4. A telecommunications system, comprising:
a network;
a plurality of network clients;
an address server including:
a plurality of user address books having a plurality of entries each entry including a name associated with a corresponding telephone number and one or more fields defining user contexts;
a voice detector configured to detect audio user input;
a search engine configured to receive the audio input from the voice detector and search the address book for entries associated with the audio user input, the audio user input including one or more user contexts, and configured to output one or more numbers corresponding to the audio input; and
a dialer configured to dial a selected one of the one or more output numbers such that a client endpoint can call the number.

5. A system in accordance with claim 4, further including a presence system wherein the search engine is configured to filter the output one or more numbers according to a presence status.

6. A system in accordance with claim 5, further including means for selecting which of the one or more numbers is to be used by the dialer for calling.

7. A system in accordance with claim 6, wherein a plurality of network clients are configured to use the dialer.

8. A telecommunications device, comprising:
an address book including a plurality of entries of party names and addresses, the entries including user-defined party contexts;
a voice recognition unit configured to receive user input, the user input including names, numbers, and contexts of address book entries;
a user context control agent configured to receive context inputs from the voice recognition unit and identify corresponding names and numbers therefrom; and
an autodialer configured to dial a number identified by the user context control agent.

9. A telecommunications device in accordance with claim 8, further including a presence and availability service configured to filter numbers identified by the user context control agent by a presence state.

10. A telecommunications device in accordance with claim 8, further including a presence and availability client configured to filter numbers identified by the user context control agent by a presence state.

11. A telecommunications device in accordance with claim 8, wherein the voice recognition unit is configured to provide a user with a list of matches if more than one number corresponds to an identified context.

12. A telecommunications device in accordance with claim 11, wherein the voice recognition unit is configured to receive a user input selecting a number if more than one number corresponds to an identified context and wherein the autodialer is configured to dial the number.

13. A telecommunications method, comprising:
storing a plurality of party names and numbers in association with one or more user-defined party contexts;
receiving a voice input corresponding to a party context;
identifying one or more telephone numbers corresponding to the party context; and
automatically dialing a number corresponding to the party context.

14. A telecommunications method in accordance with claim 13, further including providing an output to a user of a plurality of numbers corresponding to the party context.

15. A telecommunications method in accordance with claim 14, further including autodialing one of said a plurality of numbers corresponding to the party context responsive to a user selection.

16. A telecommunications method in accordance with claim 13, further including determining a presence state of a party corresponding to a number associated with the party context.

17. A telecommunications method in accordance with claim 16, further including providing an output to a user of a plurality of numbers corresponding to the party context and an available presence state.

18. A telecommunications method in accordance with claim 17, further including autodialing one of said a plurality of numbers corresponding to the party context and available presence state responsive to a user selection.
